(19) United States
(12) Patent Application Publication
(10) Pub. No.: US 2019/0358666 A1
(43) Pub. Date: Nov. 28, 2019

(54) CUP ROTATION SYSTEM

(71) Applicant: RICHARD ALEXANDER GILL, JR., CAPE CORAL, FL (US)

(72) Inventor: RICHARD ALEXANDER GILL, JR., CAPE CORAL, FL (US)

(21) Appl. No.: 16/537,540

(22) Filed: Aug. 10, 2019

Related U.S. Application Data
(60) Provisional application No. 62/718,171, filed on Aug. 13, 2018.

(51) Int. Cl. B05C 13/02; B05C 11/08; B05C 1/02; B05D 1/00

(52) U.S. Cl. CPC B05C 13/025; B05D 1/002; B05C 1/022; B05C 11/08

(57) ABSTRACT

A cup rotation system can include a motor configured to rotate a shaft, a form engagable with a cup, a first coupler engaged with the shaft, a second coupler engaged with the form, and a magnet fixed to the first or second coupler. At least a portion of the system is formed of a ferromagnetic material, and the magnet removably connects the second coupler to the shaft via magnetic coupling to render the form in rotatable communication with the shaft.

### RELATED DOCUMENTS

This document is related to, incorporates by reference in its entirety, and claims the priority benefit of U.S. Provisional Patent Application Ser. No. 62/718,171 entitled “Magnetic Shaft Attachment System for a Rotisserie Unit” and filed on Aug. 13, 2018 by the same inventor Richard Alexander Gill.

### FIELD OF THE INVENTION

The present invention relates to cup rotation devices, and more specifically, to cup rotation systems.

### BACKGROUND OF THE INVENTION

Cup exteriors have been decorated in various ways, including the application of paints, application of decals, and fixation of three-dimensional elements. To preserve such decorative aspects, a layer of transparent or translucent material has been applied over the decorative aspects, thereby sealing these aspects from physical damage. One such material used is an epoxy, which can be applied in liquid form that dries or cures. To obtain an even epoxy layer, cup turners or cup rotisseries have been used to rotate cups during the application and/or curing stages.

### SUMMARY OF THE INVENTION

It is an object of the present invention to provide a cup rotation system.

It is another object of the present invention to provide a cup rotation system that overcomes at least one deficiency in the prior art.

In an exemplary embodiment of the present invention, a cup rotation system can include a motor configured to rotate a shaft connected thereto, the shaft having a first end in rotatable communication with the motor, and a second end; a form complementarily shaped to engagably fit within a cup cavity; a first coupler engaged with the shaft; a second coupler engaged with the form; and a magnet fixed to the second coupler.

In an exemplary aspect of the present invention, at least a portion of said system is formed of a ferromagnetic material, and the magnet removably connects the second coupler to the shaft via magnetic coupling with the at least a portion, such that the form is in rotatable communication with the shaft.

Any combination of the following are additional exemplary aspects of the present invention: the first coupler can be coaxially engaged with the shaft; the second coupler can be coaxially engaged with the form; the shaft, first coupler, second coupler, and form can be rotatable around a single axis; the first coupler can include the at least a portion; and the magnet can be a ring-shaped magnet.

In another exemplary embodiment, the first coupler can include a first flange portion and another ring-shaped magnet attached to the first flange portion, the second coupler can include a second flange portion, and the magnet can removably attach the second coupler to the shaft via magnetic coupling with the other ring-shaped magnet.

In another exemplary aspect, such a system can include plural forms to accommodate different sized cups.

These and other exemplary aspects and embodiments of the present invention are further described herein.

### BRIEF DESCRIPTION OF THE DRAWINGS

FIG. 1a illustrates an exemplary cup rotation system having a motor with rotate a shaft connected thereto, first and second couplers, a magnet, and a form.

FIG. 1b illustrates an exemplary cup rotation system with an exemplary cup engaged with an exemplary form.

FIG. 2 illustrates an exemplary cup rotation system with a magnet engagable with an exemplary first coupler.

FIG. 3 illustrates an exemplary cup rotation system with a magnet engagable with an exemplary second coupler.

FIG. 4a illustrates an exemplary shaft, first and second couplers, and magnet.

FIG. 4b illustrates an exemplary shaft, first and second couplers, and magnet engaged with the second coupler.

FIG. 4c illustrates an exemplary shaft, a first magnet engaged with a first coupler, and a second magnet engaged with a second coupler.

FIG. 5a illustrates an exemplary form with an exemplary second coupler connected thereto.

FIG. 5b illustrates another exemplary form with an exemplary second coupler connected thereto.

### DETAILED DESCRIPTION

It should be noted that this disclosure includes a plurality of embodiments, with a plurality of elements and aspects, and such elements and aspects need not necessarily be interpreted as being conjunctively required by one or more embodiments of the present invention. Rather, all combinations of the one or more elements and/or aspects can enable a separate embodiment of the present invention, which may be claimed with particularity in this or any one or more future filed Non-Provisional patent applications. Moreover, any particular materials, structures, and/or sizes disclosed herein, whether expressly or implicitly, are to be construed strictly as illustrative and enabling, and not necessarily limiting. Therefore, it is expressly set forth that such materials, structures, and/or sizes independently or in any combination of one of more thereof, are merely illustratively representative of one or more embodiments of the present invention and are not to be construed as necessary in a strict sense.

Further, to the extent the same element or aspect is defined differently within this disclosure, whether expressly or implicitly, the broader definition is to take absolute precedence, with the distinctions encompassed by the narrower definition to be strictly construed as optional.

Illustratively, perceived benefits of the present invention can include functional utility, whether expressly or implicitly stated herein, or apparent herefrom. However, it is expressly set forth that these benefits are not intended as exclusive. Therefore, any explicit, implicit, or apparent benefit from the disclosure herein is expressly deemed as applicable to the present invention.

According to the present invention, any portion of a cup rotation system can be formed from any combination of functionally compatible materials, such as one or more of plastic, rubber, wood, metal, ferromagnetic, crystalline material, or any other man-made or naturally occurring material, for example and not in limitation, insofar as the same is functionally consistent with the invention.

According to an exemplary embodiment of the present invention, a cup rotation system can include the following: a motor configured to rotate a shaft, a form, a first coupler, a second coupler, and a magnet. The first coupler can be engaged with the shaft, the second coupler can be engaged with the form, and the magnet can attach the second coupler to the shaft via magnetic coupling with at least a portion of the cup rotation system that is ferromagnetic, such that the form is in rotatable communication with the shaft. In exemplary operation of the system, with a cup engaged with the form, rotation of the shaft via the motor can rotate the cup, such that a liquid epoxy can be applied to the exterior of the cup as the cup rotates.

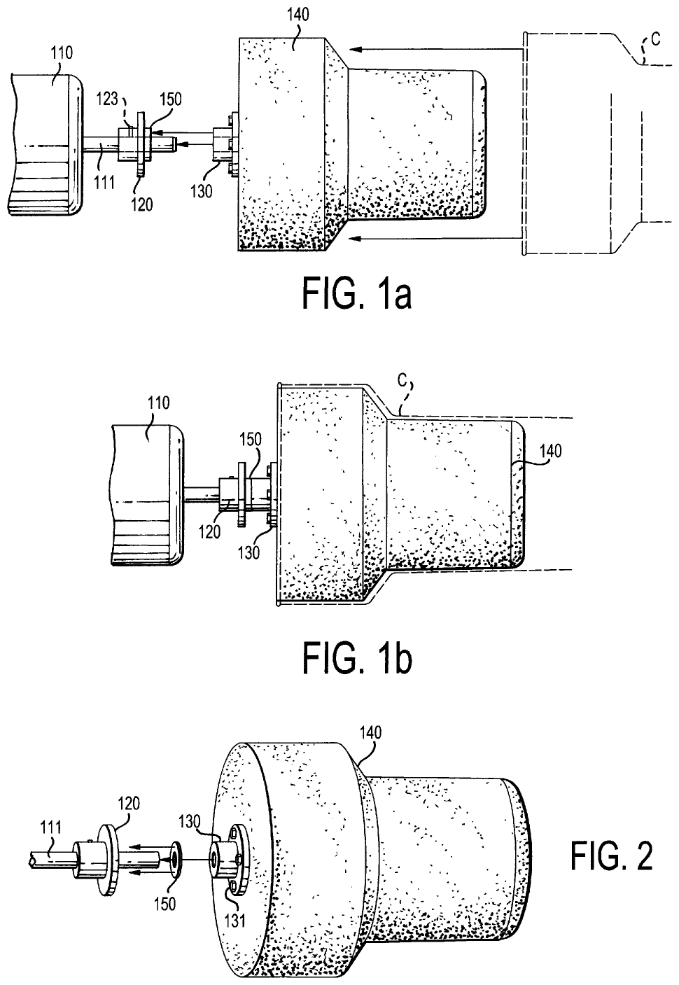

FIGS. 1a and 1b illustrate an exemplary embodiment of a cup rotation system 100, in which a motor 110 can rotate a shaft 111 connected thereto, with the shaft having a first end 112 in rotatable communication with the motor, and a second opposite end 113. In exemplary aspects, motor 110 can be electric or manual, and can rotate at a variable or fixed velocity, which can also be user-selectable insofar as desired.

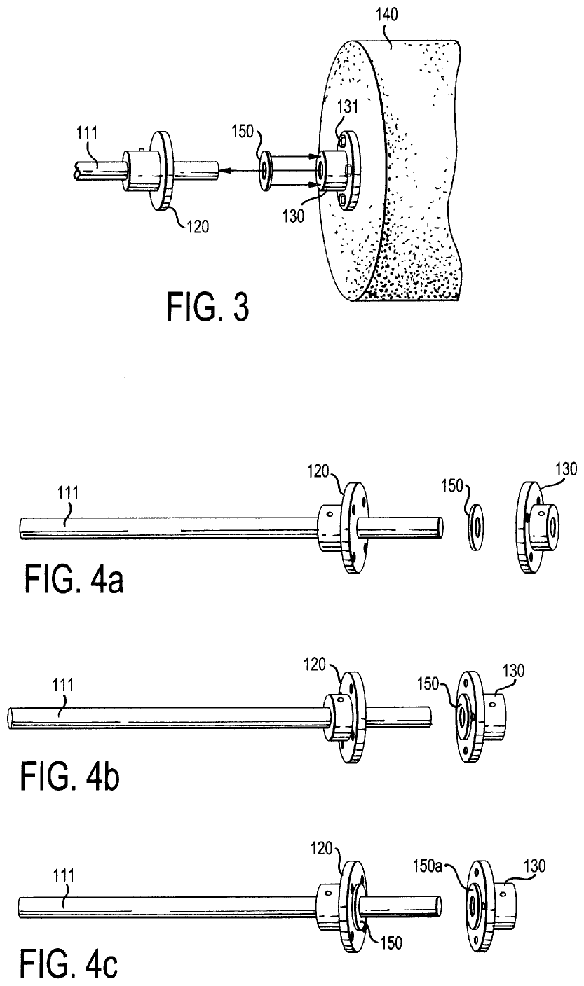

As further illustrated in FIGS. 1a and 1b, a first coupler 120 can be engaged with shaft 111 and a second coupler 130 can be engaged with a form 140. For example and not in limitation, engagement can include first coupler 120 being in contact with shaft 111, or connected thereto directly or indirectly. Further, first coupler 120 can provide a structural and/or ferromagnetic base to facilitate connection of second coupler 130 to shaft 111. In exemplary aspects, as illustrated in FIGS. 2 and 3, first coupler 120 can be provided with a hole 121 through which shaft 111 can pass, and an aperture 122 through which a set screw 123 can engage and abut, and fix the first coupler to, shaft 111. Accordingly, in one exemplary configuration, first coupler 120 can engage shaft 111 via sliding over second end 113 and thereafter be fixed to the shaft via set screw 123. However, it should be noted that first coupler 120 can be provided in any desired shape, size, and configuration insofar as functionally consistent with its engagement with shaft 111 and purpose of facilitating connection of second coupler 130 to the shaft.

In another exemplary aspect, as illustrated in FIGS. 2 and 3, second coupler 130 can be engaged with form 140 via one more fasteners 131, such that the second coupler and form corotate. However, second coupler 130 can be corotatably attached to form 140 via any one or more attachment elements and in any desired manner insofar as compatible with the present invention, such as for example and not in limitation, via one or more magnetic elements, an adhesive, hook and loop structures, etc. As with first coupler 120, second coupler 130 also can be provided in any desired shape, size, and configuration insofar as functionally consistent with its corotatable engagement with form 140.

In another exemplary aspect of the present invention, a magnet 150 can be provided to removably connect second coupler 130 to shaft 111. As illustratively shown in FIGS. 2 and 3, magnet 150 can be provided with a ring shape, and can engage first and/or second coupler 120, 130 in effectuating the removable connection of the second coupler to the shaft. Further, engagement of magnet 150 can be effectuated via any manner and/or cooperative structure desired, including, for example and not in limitation, magnetic bonding with any combination of first coupler 120, second coupler 130, and any other portion of system 100. It should be noted that while magnet 150 has been illustratively shown as having a ring shape, a magnet can be provided in any desired shape, size, and configuration insofar as it facilitates the removable connection of second coupler 130 to shaft 111.

FIGS. 4a and 4b illustrate exploded views of exemplary shaft 111, first and second couplers 120, 130, and magnet 150. As illustrated in FIG. 4a, in an exemplary embodiment, first coupler 120 can slidably engage shaft 111 with magnet 150, which can engage either the first or second coupler 120, 130. FIG. 4b illustrates magnet 150 engaged with second coupler 130.

In another exemplary aspect, optionally, a cup rotation system can further include another magnet 150a, which can be provided to facilitate the removable connection of second coupler 130 to shaft 111. FIG. 4c illustrates yet another exemplary embodiment, in which first magnet 150 can be engaged with first coupler 120 and a second magnet 150a can be engaged with second coupler 130. Accordingly, first and second coupler 120, 130 can engage each other to effectuate removable connection second coupler to shaft 111.

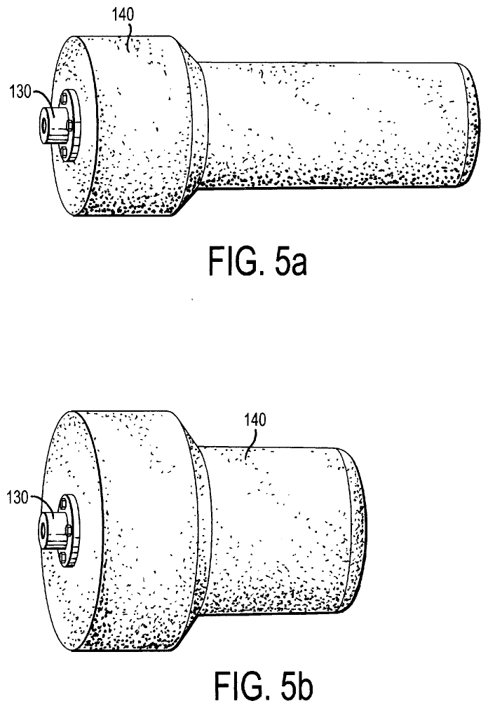

In another exemplary aspect of the present invention, form 140 can be provided in any desired shape, size, and configuration to accommodate different sized cups. Further, form 140 can be formed from any desired material or materials that render the same functionally compatible with the present invention. For example and not in limitation, form 140 can be formed from a foam or a deformable material that can snugly fit within the cavity of a cup (as illustratively shown in FIG. 1b), so as to frictionally hold a cup in place, and can be provided with a shape that is complementary to a cup cavity. As illustrated in FIGS. 5a and 5b, form 140 can be provided with different outside diameters to accommodate cups having different sized cavities.

It will be apparent to one of ordinary skill in the art that the manner of making and using the claimed invention has been adequately disclosed in the above-written description of the exemplary embodiments and aspects.

It should be understood, however, that the invention is not necessarily limited to the specific embodiments, aspects, arrangement, and components shown and described above, but may be susceptible to numerous variations within the scope of the invention. For example, while the present invention is illustratively shown having particularly shaped elements, such as first and second couplers 120, 130, such shapes are strictly for illustrative purposes and should not be interpreted as necessarily limiting such elements to such shapes or even manners in which such elements interrelate or engage with other elements.

Therefore, the specification and drawings are to be regarded in an illustrative and enabling, rather than a restrictive, sense.

Accordingly, it will be understood that the above description of the embodiments of the present invention are susceptible to various modifications, changes, and adaptations, and the same are intended to be comprehended within the meaning and range of equivalents of the appended claims.

Therefore, I claim:

1. A cup rotation system, comprising:
a motor configured to rotate a shaft connected to said motor, the shaft having a first end in rotatable communication with the motor, and a second end;
a form complementarily shaped to engagably fit within a cup cavity;
a first coupler engaged with the shaft;
a second coupler engaged with said form; and
a magnet fixed to one of said first coupler and said second coupler;
wherein at least a portion of said system is formed of a ferromagnetic material, and said magnet removably connects said second coupler to the shaft via magnetic coupling with the at least a portion, such that said form is connected to the second end and in rotatable communication with the shaft.

2. The system of claim 1, wherein said first coupler is corotatably engaged with the shaft.

3. The system of claim 2, wherein said second coupler is corotatably engaged with said form.

4. The system of claim 1, wherein said second coupler is corotatably engaged with said form.

5. The system of claim 1, wherein at least two of the shaft, said first coupler, said second coupler, and said form are corotatable.

6. The system of claim 1, wherein said first coupler includes the at least a portion.

7. The system of claim 1, wherein said magnet is a ring-shaped magnet.

8. The system of claim 7, wherein said first coupler includes a first flange portion and another ring-shaped magnet attached to the first flange portion, said second coupler includes a second flange portion, and said magnet removably connects said second coupler to the shaft via magnetic coupling with the other ring-shaped magnet.

9. The system of claim 1, where the at least a portion is another magnet engaged with the shaft.

10. The system of claim 1, further comprising
another form complementarily shaped to engagably fit within another cup cavity larger than the cup cavity; and
a third coupler engaged with said other form; and
another magnet fixed to said third coupler;
wherein said other magnet removably connects said third coupler to the shaft via magnetic coupling with the at least a portion, such that said other form is connected to the second end and in rotatable communication with the shaft.

11. The system of claim 10, wherein said first coupler is corotatably engaged with the shaft.

12. The system of claim 11, wherein said third coupler is corotatably engaged with said other form.

13. The system of claim 10, wherein said third coupler is corotatably engaged with said other form.

14. The system of claim 10, wherein at least two of the shaft, said first coupler, said second coupler, and said other form are corotatable.

15. The system of claim 10, wherein said first coupler includes the at least a portion.

16. The system of claim 10, wherein said magnet and said other magnet are configured with a ring shape.
